(19) United States
(12) Patent Application Publication
(10) Pub. No.: US 2020/0007947 A1
(43) Pub. Date: Jan. 2, 2020

(54) METHOD AND DEVICE FOR GENERATING REAL-TIME INTERPRETATION OF A VIDEO

(71) Applicant: Wipro Limited, Bangalore (IN)

(72) Inventors: Vinutha Bangalore NarayanaMurthy, Bangalore (IN); Manjunath Ramachandra Iyer, Bangalore (IN)

(21) Appl. No.: 16/107,054

(22) Filed: Aug. 21, 2018

(30) Foreign Application Priority Data
Jun. 30, 2018 (IN) 201841024446

(51) Int. Cl. H04N 21/488; H04N 21/8549; H04N 21/422; H04N 21/4728; G06F 3/01

(52) U.S. Cl. CPC H04N 21/4884; H04N 21/8549; G06F 3/013; H04N 21/4728; H04N 21/42201

(57) ABSTRACT

A method generating real-time interpretation of a video is disclosed. The method includes capturing, by a media capturing device, a region of attention of a user accessing the video from a screen associated with the media capturing device to determine an object of interest. The method also includes generating a text script from an audio associated with the video. The method further includes determining one or more subtitles from the text script based on the region of attention of the user. The method further includes generating a summarized content of the one or more subtitles based on a time lag between the video and the one or more subtitles. Moreover, the method includes rendering the summarized content in one or more formats to the user over the screen of the media capturing device.

This application claims the benefit of Indian Patent Application Serial No. 201841024446, filed Jun. 30, 2018, which is hereby incorporated by reference in its entirety.

### FIELD

This disclosure relates generally to processing of videos, and more particularly to a method and device for generating real-time interpretation of a video.

### BACKGROUND

Today, videos (for instance, movies, live telecasts or any recorded videos) are being created in different languages for consumption by different people. However, most people who find a video interesting may not follow a language used in the video. Also, people who are hearing impaired and verbally impaired, and the like, are also unable to follow the video.

To overcome above issues, options of viewing subtitles for the video in a preferred language or gesture-related interpretations are provided. Such provisions, however, are difficult to provide in a real-time scenario of viewing the video. This is due to a time lag and unsynchronization between the subtitles and the video. For example, in the real-time scenario, people who may not follow the language used in the video, and people who are hearing impaired and verbally impaired, may watch the movie or a live stream video but with the time lag between the subtitles and the video, which does not qualify for a good user experience.

### SUMMARY

In one embodiment, a method for generating real-time interpretation of a video is disclosed. In one embodiment, the method may include capturing, by a media capturing device, a region of attention of a user accessing the video from a screen associated with the media capturing device to determine an object of interest. The method may further include generating, by the media capturing device, a text script from an audio associated with the video. The method may further include determining, by the media capturing device, one or more subtitles from the text script based on the region of attention of the user. Further, the method may include generating, by the media capturing device, a summarized content of the one or more subtitles based on a time lag between the video and the one or more subtitles. Moreover, the method may include rendering, by the media capturing device, the summarized content in one or more formats to the user over the screen of the media capturing device.

In another embodiment, a media capturing device for generating real-time interpretation of a video is disclosed. The media capturing device includes a processor and a memory communicatively coupled to the processor, wherein the memory stores processor instructions, which, on execution, causes the processor to capture a region of attention of a user accessing the video from a screen associated with the media capturing device to determine an object of interest. The processor instructions further cause the processor to generate a text script from an audio associated with the video and to determine one or more subtitles from the text script based on the region of attention of the user. The processor instructions further cause the processor to generate a summarized content of the one or more subtitles based on a time lag between the video and the one or more subtitles. The processor instructions further cause the processor to render the summarized content in one or more formats to the user over the screen of the media capturing device.

In yet another embodiment, a non-transitory computer-readable medium storing computer-executable instructions for generating real-time interpretation of a video is disclosed. In one example, the stored instructions, when executed by a processor, may cause the processor to perform operations including capturing a region of attention of a user accessing the video from a screen associated with the media capturing device to determine an object of interest. The operations may further include generating a text script from an audio associated with the video. The operations may further include determining one or more subtitles from the text script based on the region of attention of the user. The operations may further include generating a summarized content of the one or more subtitles based on a time lag between the video and the one or more subtitles. The operations may further include rendering the summarized content in one or more formats to the user over the screen of the media capturing device.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram illustrating an environment for generating real-time interpretation of a video, in accordance with an embodiment;

FIG. 2 illustrates a block diagram of a media capturing device for generating real-time interpretation of a video, in accordance with an embodiment;

FIG. 3 illustrates a flowchart of a method for generating real-time interpretation of a video, in accordance with an embodiment; and

FIG. 4 illustrates a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

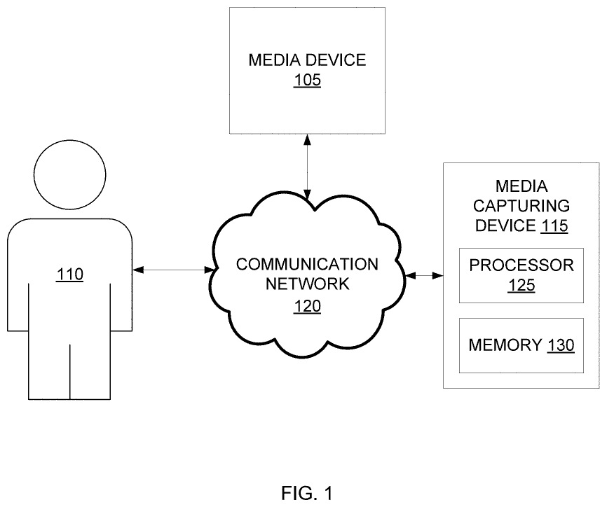

In one embodiment, an environment 100 for generating real-time interpretation of a video is illustrated in the FIG. 1, in accordance with an embodiment. The environment 100 may include a media device 105, a user 110, a media capturing device 115, and a communication network 120. The media device 105 and the media capturing device 115 may be computing devices having video processing capability. Examples of the media device 105 may include, but are not limited to, server, desktop, laptop, notebook, netbook, tablet, smartphone, mobile phone, application server, or the like. Examples of the media capturing device 115 may include, but are not limited to, a head mounted device, a wearable smart glass, or the like.

The media capturing device 115 may interact with the media device 105 and the user 110 over the communication network 120 for sending or receiving various data. The communication network 120 may be a wired or a wireless network and the examples may include, but are not limited to the Internet, Wireless Local Area Network (WLAN), Wi-Fi, Long Term Evolution (LTE), Worldwide Interoperability for Microwave Access (WiMAX), and General Packet Radio Service (GPRS).

The media capturing device 115 may generate a real-time interpretation of a video to the user 110. In an example, the user 110 may be wearing the media capturing device 115, for example a head-mounted device. The video is provided to the media capturing device 115 from the media device 105. To this end, the media capturing device 115 may be communicatively coupled to the media device 105 through the communication network 120. The media device 105 and the media capturing device 115 may include databases that further include one or more media files, for example videos. The user 110 of the media capturing device 115 may choose to select the video from a database in the media device 105 or from a database in the media capturing device 115 itself.

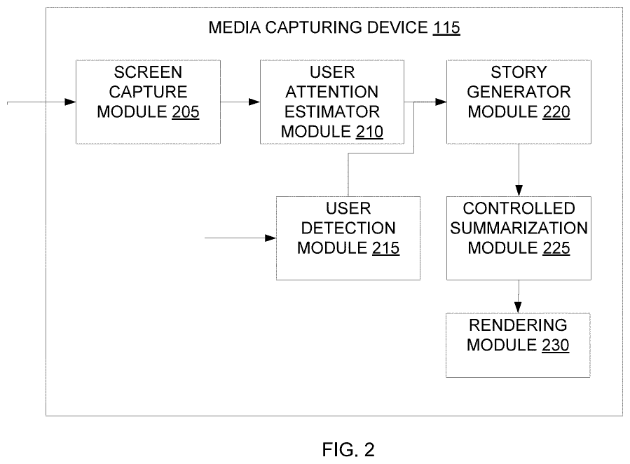

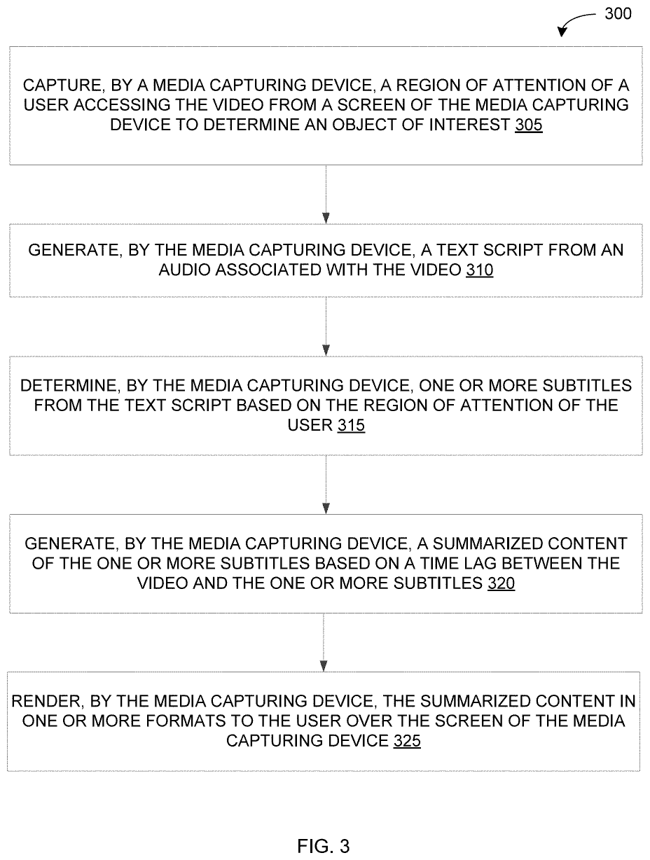

As will be described in greater detail in conjunction with FIG. 2 and FIG. 3, the media capturing device 115 may capture a region of attention of the user accessing the video from a screen associated with the media capturing device 115 to determine an object of interest. The media capturing device 115 may further generate a text script from an audio associated with the video. The media capturing device 115 may further determine one or more subtitles from the text script based on the region of attention of the user. Thereafter, the media capturing device 115 may generate a summarized content of the one or more subtitles based on a time lag between the video and the one or more subtitles. Further, the media capturing device 115 renders the summarized content in one or more formats to the user over the screen.

In order to perform the above discussed functionalities, the media capturing device 115 may include a processor 125 and a memory 130. The memory 130 may store instructions that, when executed by the processor 125, cause the processor 125 to generate a real-time interpretation of the video as discussed in greater detail in FIG. 2 and FIG. 3. The memory 130 may be a non-volatile memory or a volatile memory. Examples of non-volatile memory, may include, but are not limited to a flash memory, a Read Only Memory (ROM), a Programmable ROM (PROM), Erasable PROM (EPROM), and Electrically EPROM (EEPROM) memory. Examples of volatile memory may include, but are not limited Dynamic Random Access Memory (DRAM), and Static Random-Access memory (SRAM).

The memory 130 may also store various data (for example, images of the video, coordinates associated with region of attention of the user, audio of the video, text script of the audio, the one or more subtitles, and the summarized content, and the like) that may be captured, processed, and/or required by the media capturing device 115.

The media capturing device 115 may further include a user interface (not shown in FIG. 1) through which the media capturing device 115 may interact with the user 110 and vice versa. By way of an example, the user interface may be used to display the summarized content, summarized by the media capturing device 115, in one or more formats to the user. By way of another example, the user interface may be used by the user 110 to provide inputs to the media capturing device 115.

Referring now to FIG. 2, a functional block diagram of the media capturing device 115, is illustrated in accordance with an embodiment. The media capturing device 115 may include various modules that may perform various functions so as to generate real-time interpretation of a video. The media capturing device 115 may include a screen capture module 205, a user attention estimator module 210, a user detection module 215, a story generator module 220, a controlled summarization module 225 and a rendering module 230. As will be appreciated by those skilled in the art, all such aforementioned modules 205-230 may be represented as a single module or a combination of different modules or may reside in the processor 125 or memory 130 of the media capturing device 115. Moreover, as will be appreciated by those skilled in the art, each of the modules 205-230 may reside, in whole or in parts, on one device or multiple devices in communication with each other.

The media capturing device 115 may receive the video for which a real-time interpretation is generated. As described in FIG. 1, the video can be received either from a database of the media device 105 or from a database of the media capturing device 115 itself. The video is input or streamed to the screen capture module 205 which captures video from a screen when the user 110 puts on the media capturing device 115 (also referred to as user invocation of the media capturing device 115) and starts to watch the video. The video from the screen is captured through a plurality of techniques, for example through an external camera, through an auxiliary streaming of the video (for which a local video decoder on the media capturing device 115 is required), and the like. The video is to be buffered to ensure synchronization with subtitles that are generated in subsequent modules. The audio from the video is also captured with streaming.

The user attention estimator module 210 coupled to the screen capture module 205 measures at least one eye position of the user accessing the video. In some embodiments, the measurement is done using an internal camera on the media capturing device. The internal camera indicates which part of the screen the user 110 is watching at any point of time. The internal camera further returns coordinates of the object of interest in the video. In some embodiments, the coordinates are required to be averaged out before using to compensate for spurious movements.

The user detection module 215 receives user credentials and identifies type of the user 110, for example if the user is a normal user, a hearing impaired user, a verbally impaired user, and the like. The user may select to view subtitles in desired language and slangs that are supported in the media capturing device 115.

A text script is generated by the story generator module 220 from the audio and linked to characters in the video. The linking is implemented by identifying, for example through lip movement, characters who are speaking. From the text script, one or more subtitles are then generated. In some embodiments, the subtitles are generated based on the region of attention of the user 110, with an emphasis on the characters in the region of attention. In some embodiments, the subtitles are generated over the cloud and streamed to the media capturing device 115.

The controlled summarization module 225 generates a summarized content of the one or more subtitles based on a time lag between the video and the one or more subtitles. If the time lag between the video and the one or more subtitles increases or decreases, degree of summarization also increases or decreases, accordingly.

The rendering module 230 renders the summarized content in one or more formats to the user 110 over the screen of the media capturing device 115. The rendering module 230 also helps in synchronization of the audio, the video and the one or more subtitles. A method of generating the real-time interpretation of the video is further described in detail in conjunction with FIG. 3.

It should be noted that the media capturing device 115 may be implemented in programmable hardware devices such as programmable gate arrays, programmable array logic, programmable logic devices, or the like. Alternatively, the media capturing device 115 may be implemented in software for execution by various types of processors. An identified module of executable code may, for instance, include one or more physical or logical blocks of computer instructions which may, for instance, be organized as an object, procedure, function, or other construct. Nevertheless, the executables of an identified module need not be physically located together, but may include disparate instructions stored in different locations which, when joined logically together, comprise the module and achieve the stated purpose of the module. Indeed, a module of executable code may be a single instruction, or many instructions, and may even be distributed over several different code segments, among different applications, and across several memory devices.

As will be appreciated by those skilled in the art, a variety of processes may be employed for identifying relevant keywords from a document. For example, the exemplary environment 100 and the media capturing device 115 may identify relevant keywords by the processes discussed herein. In particular, as will be appreciated by those of ordinary skill in the art, control logic and/or automated routines for performing the techniques and steps described herein may be implemented by the environment 100 and the media capturing device 115, either by hardware, software, or combinations of hardware and software. For example, suitable code may be accessed and executed by the one or more processors on the environment 100 to perform some or all of the techniques described herein. Similarly, application specific integrated circuits (ASICs) configured to perform some or all of the processes described herein may be included in the one or more processors on the environment 100.

Referring now to FIG. 3, a flowchart of a method 300 for generating real-time interpretation of a video is illustrated, in accordance with an embodiment. A user, for example the user 110 of FIG. 1, wears or mounts a media capturing device, for example the media capturing device 115 of FIG. 1, and starts watching a video, for example a movie at home or in a movie hall, or a live telecast. This is one example of user invocation of the media capturing device. In an example, the media capturing device may be an augmented device. In some embodiments, the media capturing device is coupled to a media device, for example the media device 105 of FIG. 1. In such cases, the user chooses the video and the video is transmitted from the media device and viewed by the user on the media capturing device. This is another example of the user invocation of the media capturing device.

In some embodiments, one or more image processing methods and natural language processing methods are used for generating the real-time interpretation of the video.

In some embodiments, the method 300 includes classifying, by the media capturing device, the user into one or more user types to address requirements of the user. Examples of the one or more user types of the user include, but are not limited to, a normal user, a hearing impaired user, a verbally impaired user, and the like. For instance, the requirements of the normal user may be to view subtitles of the video as text in a preferred language and slang, the requirements of the hearing impaired user and the verbally impaired user may be to view the subtitles of the video either as text, or as a sign language or both, and the like.

In some embodiments, the method 300 includes capturing one or more images of the video being accessed by the user from a screen associated with the media capturing device. The one or more images of the video is captured with an external camera on the media capturing device.

At step 305, the method 300 includes capturing, by the media capturing device, a region of attention of the user accessing the video from the screen associated with the media capturing device to determine an object of interest. In some embodiments, the region of attention of the user is captured on the user invocation of the media capturing device. In some embodiments, the region of attention of the user is captured by measuring, by the media capturing device, at least one eye position of the user accessing the video. The at least one eye position of the user accessing the video is captured with an internal camera on the media capturing device that provides associated coordinates of the object of interest in the video. In some embodiments, the media capturing device includes a socket to insert hardware extension.

At step 310, the method 300 includes generating, by the media capturing device, a text script from an audio associated with the video. The audio associated with the video is streamed to the media capturing device. The audio is then converted into the text script by the media capturing device. In one example, the audio is streamed into a dongle device attached to the media capturing device. The dongle device, including necessary modules, may be used to convert the audio into the text script. The dongle device supports connectivity including radio frequency (RF), Bluetooth, and also supports processing techniques including audio/video decoding, application programming interface (API) calls to cloud, and the like.

At step 315, the method 300 includes determining, by the media capturing device, one or more subtitles from the text script based on the region of attention of the user. In some embodiments, the one or more subtitles are determined from the text script by mapping dialogues of the text script to characters in the video.

In some embodiments, the mapping of the dialogues of the text script is performed by first extracting the characters in a scene, for example by object recognition method, face detection method, and the like. The character that is speaking or making utterances in the scene is then identified. The utterances are mapped with associated character. Initially, name of the character may not be known and a descriptive phrase, for example tall man, short man, round faced woman, and the like may be assigned. Subsequently, from conversations in the video, names of the characters would be identified and taken care of during the mapping.

After the mapping, one or more characters from the characters is determined in the region of attention of the user. Only one or more dialogues associated with the one or more characters are emphasized or given importance, for example around 80%. Thereafter, one or more dialogues of the one or more characters in the region of attention is rendered to the user as the one or more subtitles in a desired language.

At step 320, the method 300 includes generating, by the media capturing device, a summarized content of the one or more subtitles based on a time lag between the video and the one or more subtitles. The time lag and small computational overheads between the video and the one or more subtitles may occur while buffering images of the video. Further, in order to support real-time consumption of the video, it is required to generate the one or more subtitles at a fixed rate. However, when the subtitles have a time lag, for example of 1 second, there is a need to close such gap by summarizing further subtitles.

The summarized content is thereby generated in order to synchronize the one or more subtitles with the video. The summarized content of the one or more subtitles is generated based on knowledge of the one or more characters involved in the scene of the video. It may be understood that the knowledge of the one or more characters may include information regarding which character is speaking, what is being spoken at any point of time, and the like. In an example, the dongle device attached to the media capturing device may be used to generate the summarized content.

In some embodiments, the summarized content is generated by identifying one or more upcoming subtitles in the video in accordance with the time lag, determining the subtitles that are of interest to the user from the one or more upcoming subtitles based on the region of attention (in one example, the user is interested in watching wheels (object of interest) of a car (region of attention) in the video being played), and summarizing content of the subtitles that are of interest to the user (for instance, in the above example, the summarized content may include sentences referring to or containing the wheels of the car. If there is no such sentences associated with the wheels of the car then sentences referring to or containing the car may appear in the summarized content).

In some embodiments, different degrees of summarization may be provided to the media capturing device based on the time lag. For instance, it may provide key information based on specific information such as context of a video, user comments or reviews of a movie in social media. For example, social media based information may provide indication on prominence of different scenes through user comments and helps to determine the key information. The key information based on the specific information may be helpful for selective summarization. The key information serves as minimum description (either direct or narrated) required in understanding a scene of the video.

Further, additional information may be streamed if the processing of the video takes more time, so as to maintain audio and scene synchronization. At such scenario, some information may be omitted or summarized. Thus, raw audio gives sum of key information, summarized information and omitted information. After providing the key information, the summarization is done depending on the time gap between a video and an audio description or a subtitle rendered.

At step 325, the method 300 includes rendering, by the media capturing device, the summarized content in one or more formats to the user over the screen. The summarized content is augmented on the screen viewed by the user. In some embodiments, the one or more formats of the summarized content of the one or more subtitles includes at least one of a text format, a sign language format, and the like. In some embodiments, the text format is in a desired language of the user. In some embodiments, the sign language format is generated by providing the summarized content to a sign language generator module. In some embodiments, the sign language format is generated and rendered even for the normal user along with the text format for effective communication and full understanding if few words are missed out in the audio.

As will be also appreciated, the above described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

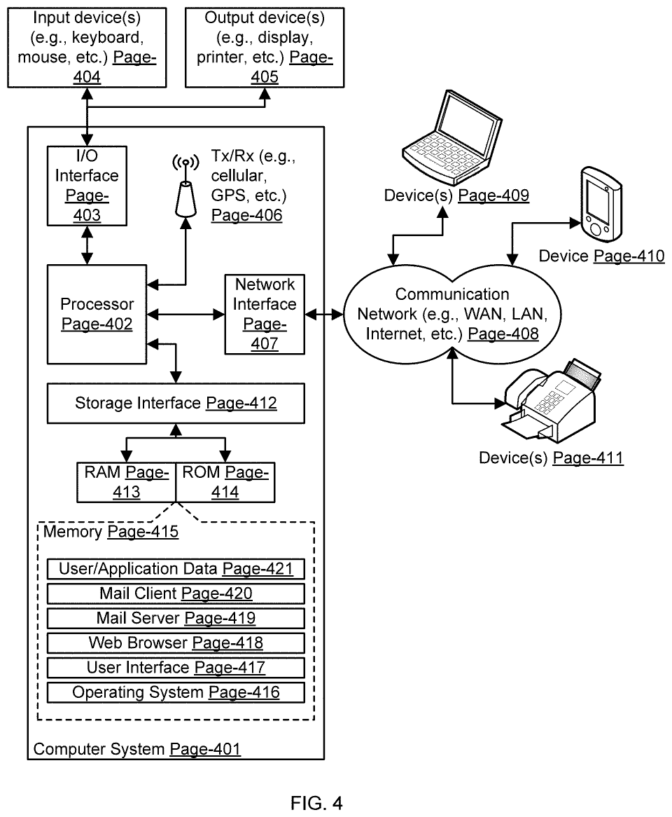

The disclosed methods and systems may be implemented on a conventional or a general-purpose computer system, such as a personal computer (PC) or server computer. Referring now to FIG. 4, a block diagram of an exemplary computer system 402 for implementing various embodiments is illustrated. Computer system 402 may include a central processing unit (“CPU” or “processor”) 404. Processor 404 may include at least one data processor for executing program components for executing user- or system-generated requests. A user may include a person, a person using a device such as such as those included in this disclosure, or such a device itself. Processor 404 may include specialized processing units such as integrated system (bus) controllers, memory management control units, floating point units, graphics processing units, digital signal processing units, etc. Processor 404 may include a microprocessor, such as AMD® ATHLON® microprocessor, DURON® microprocessor OR OPTERON® microprocessor, ARM's application, embedded or secure processors, IBM® POWERPC®, INTEL'S CORE® processor, ITANIUM® processor, XEON® processor, CELERON® processor or other line of processors, etc. Processor 404 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 404 may be disposed in communication with one or more input/output (I/O) devices via an I/O interface 406. I/O interface 406 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (for example, code-division multiple access (CDMA), high-speed packet access (HSPA+), global system for mobile communications (GSM), long-term evolution (LTE), WiMax, or the like), etc.

Using I/O interface 406, computer system 402 may communicate with one or more I/O devices. For example, an input device 408 may be an antenna, keyboard, mouse, joystick, (infrared) remote control, camera, card reader, fax machine, dongle, biometric reader, microphone, touch screen, touchpad, trackball, sensor (for example, accelerometer, light sensor, GPS, gyroscope, proximity sensor, or the like), stylus, scanner, storage device, transceiver, video device/source, visors, etc. An output device 410 may be a printer, fax machine, video display (for example, cathode ray tube (CRT), liquid crystal display (LCD), light-emitting diode (LED), plasma, or the like), audio speaker, etc. In some embodiments, a transceiver 412 may be disposed in connection with processor 404. Transceiver 412 may facilitate various types of wireless transmission or reception. For example, transceiver 412 may include an antenna operatively connected to a transceiver chip (for example, TEXAS® INSTRUMENTS WILINK WL1286® transceiver, BROADCOM® BCM4550IUB8® transceiver, INFINEON TECHNOLOGIES® X-GOLD 618-PMB9800® transceiver, or the like), providing IEEE 802.6a/b/g/n, Bluetooth, FM, global positioning system (GPS), 2G/3G HSDPA/HSUPA communications, etc.

In some embodiments, processor 404 may be disposed in communication with a communication network 414 via a network interface 416. Network interface 416 may communicate with communication network 414. Network interface 416 may employ connection protocols including, without limitation, direct connect, Ethernet (for example, twisted pair 50/500/5000 Base T), transmission control protocol/internet protocol (TCP/IP), token ring, IEEE 802.11a/b/g/n/x, etc. Communication network 414 may include, without limitation, a direct interconnection, local area network (LAN), wide area network (WAN), wireless network (for example, using Wireless Application Protocol), the Internet, etc. Using network interface 416 and communication network 414, computer system 402 may communicate with devices 418, 420, and 422. These devices may include, without limitation, personal computer(s), server(s), fax machines, printers, scanners, various mobile devices such as cellular telephones, smartphones (for example, APPLE® IPHONE® smartphone, BLACKBERRY® smartphone, ANDROID® based phones, etc.), tablet computers, eBook readers (AMAZON® KINDLE® ereader, NOOK® tablet computer, etc.), laptop computers, notebooks, gaming consoles (MICROSOFT® XBOX® gaming console, NINTENDO® DS® gaming console, SONY® PLAYSTATION® gaming console, etc.), or the like. In some embodiments, computer system 402 may itself embody one or more of these devices.

In some embodiments, processor 404 may be disposed in communication with one or more memory devices (for example, RAM 426, ROM 428, etc.) via a storage interface 424. Storage interface 424 may connect to memory 430 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

Memory 430 may store a collection of program or database components, including, without limitation, an operating system 432, user interface application 434, web browser 436, mail server 438, mail client 440, user/application data 442 (for example, any data variables or data records discussed in this disclosure), etc. Operating system 432 may facilitate resource management and operation of computer system 402. Examples of operating systems 432 include, without limitation, APPLE® MACINTOSH® OS X platform, UNIX platform, Unix-like system distributions (for example, Berkeley Software Distribution (BSD), FreeBSD, NetBSD, OpenBSD, etc.), LINUX distributions (for example, RED HAT®, UBUNTU®, KUBUNTU®, etc.), IBM® OS/2 platform, MICROSOFT® WINDOWS® platform (XP, Vista/7/8, etc.), APPLE® IOS® platform, GOOGLE® ANDROID® platform, BLACKBERRY® OS platform, or the like. User interface 434 may facilitate display, execution, interaction, manipulation, or operation of program components through textual or graphical facilities. For example, user interfaces may provide computer interaction interface elements on a display system operatively connected to computer system 402, such as cursors, icons, check boxes, menus, scrollers, windows, widgets, etc. Graphical user interfaces (GUIs) may be employed, including, without limitation, APPLE® Macintosh® operating systems' AQUA® platform, IBM® OS/2® platform, MICROSOFT® WINDOWS platform (for example, AERO® platform, METRO® platform, etc.), UNIX X-WINDOWS, web interface libraries (for example, ACTIVEX® platform, JAVA® programming language, JAVASCRIPT® programming language, AJAX® programming language, HTML, ADOBE® FLASH® platform, etc.), or the like.

In some embodiments, computer system 402 may implement a web browser 436 stored program component. Web browser 436 may be a hypertext viewing application, such as MICROSOFT® INTERNET EXPLORER® web browser, GOOGLE® CHROME® web browser, MOZILLA® FIREFOX® web browser, APPLE® SAFARI® web browser, etc. Secure web browsing may be provided using HTTPS (secure hypertext transport protocol), secure sockets layer (SSL), Transport Layer Security (TLS), etc. Web browsers may utilize facilities such as AJAX, DHTML, ADOBE® FLASH® platform, JAVASCRIPT® programming language, JAVA® programming language, application programming interfaces (APis), etc. In some embodiments, computer system 402 may implement a mail server 438 stored program component. Mail server 438 may be an Internet mail server such as MICROSOFT® EXCHANGE® mail server, or the like. Mail server 438 may utilize facilities such as ASP, ActiveX, ANSI C++/C#, MICROSOFT .NET® programming language, CGI scripts, JAVA® programming language, JAVASCRIPT® programming language, PERL® programming language, PHP® programming language, PYTHON programming language, WebObjects, etc. Mail server 438 may utilize communication protocols such as internet message access protocol (IMAP), messaging application programming interface (MAPI), Microsoft Exchange, post office protocol (POP), simple mail transfer protocol (SMTP), or the like. In some embodiments, computer system 402 may implement a mail client 440 stored program component. Mail client 440 may be a mail viewing application, such as APPLE MAIL® mail client, MICROSOFT ENTOURAGE® mail client, MICROSOFT OUTLOOK® mail client, MOZILLA THUNDERBIRD® mail client, etc.

In some embodiments, computer system 402 may store user/application data 442, such as the data, variables, records, etc. as described in this disclosure. Such databases may be implemented as fault-tolerant, relational, scalable, secure databases such as ORACLE® database OR SYBASE® database. Alternatively, such databases may be implemented using standardized data structures, such as an array, hash, linked list, struct, structured text file (for example, XML), table, or as object-oriented databases (for example, using OBJECTSTORE® object database, POET® object database, ZOPE® object database, etc.). Such databases may be consolidated or distributed, sometimes among the various computer systems discussed above in this disclosure. It is to be understood that the structure and operation of the any computer or database component may be combined, consolidated, or distributed in any working combination.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

As will be appreciated by those skilled in the art, the techniques described in the various embodiments discussed above pertain to generating real-time interpretation of a video. The techniques provide for real-time interpretation of a video and renders subtitles at a user's own pace of consumption. Further, the subtitles are generated dynamically to align with portion of the video the user is currently watching. Furthermore, the subtitles can be in the user's own language, accent, slang and the like.

The specification has described method and system for generating real-time interpretation of a video. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of generating real-time interpretation of a video, the method comprising:
capturing, by a media capturing device, a region of attention of a user accessing the video from a screen of the media capturing device to determine an object of interest;
generating, by the media capturing device, a text script from an audio associated with the video;
determining, by the media capturing device, one or more subtitles from the text script based on the region of attention of the user;
generating, by the media capturing device, a summarized content of the one or more subtitles based on a time lag between the video and the one or more subtitles; and
rendering, by the media capturing device, the summarized content in one or more formats to the user over the screen of the media capturing device.

2. The method of claim 1, wherein the region of attention of the user is captured on user invocation of the media capturing device.

3. The method of claim 1, wherein the capturing the region of attention of the user comprises:
measuring, by the media capturing device, at least one eye position of the user accessing the video.

4. The method of claim 3, wherein the at least one eye position of the user accessing the video is captured with an internal camera on the media capturing device that provides associated coordinates of the screen.

5. The method of claim 1, wherein the determining the one or more subtitles from the text script comprises:
mapping, by the media capturing device, dialogues of the text script to characters in the video;
determining, by the media capturing device, one or more characters in the region of attention of the user; and
rendering, by the media capturing device, one or more dialogues of the one or more characters in the region of attention to the user as the one or more subtitles.

6. The method of claim 1, wherein the one or more formats of the summarized content of the one or more subtitles comprises at least one of a text format, and a sign language format.

7. The method of claim 1 further comprising:
classifying, by the media capturing device, the user into one or more user types to address requirements of the user.

8. A media capturing device that generates real-time interpretation of a video, the media capturing device comprising:
a processor; and
a memory communicatively coupled to the processor, wherein the memory stores processor instructions, which, on execution, causes the processor to:
capture a region of attention of a user accessing the video from a screen of the media capturing device to determine an object of interest;
generate a text script from an audio associated with the video;
determine one or more subtitles from the text script based on the region of attention of the user;
generate a summarized content of the one or more subtitles based on a time lag between the video and the one or more subtitles; and
render the summarized content in one or more formats to the user over the screen of the media capturing device.

9. The media capturing device of claim 8, wherein the region of attention of the user is captured on user invocation of the media capturing device.

10. The media capturing device of claim 8, wherein the capturing the region of attention of the user comprises:
measuring at least one eye position of the user accessing the video.

11. The media capturing device of claim 10, wherein the at least one eye position of the user accessing the video is captured with an internal camera on the media capturing device that provides associated coordinates of the screen.

12. The media capturing device of claim 8, wherein the determining the one or more subtitles from the text script comprises:
mapping dialogues of the text script to characters in the video;
determining one or more characters in the region of attention of the user; and
rendering one or more dialogues of the one or more characters in the region of attention to the user as the one or more subtitles.

13. The media capturing device of claim 8, wherein the one or more formats of the summarized content of the one or more subtitles comprises at least one of a text format, and a sign language format.

14. The media capturing device of claim 8, wherein the processor instructions further cause the processor to classify the user into one or more user types to address requirements of the user.

15. A non-transitory computer-readable medium having stored thereon instructions comprising executable code which when executed by one or more processors, causes the one or more processors to:
capture a region of attention of a user accessing a video from a screen of a media capturing device to determine an object of interest;
generate a text script from an audio associated with the video;
determine one or more subtitles from the text script based on the region of attention of the user;
generate a summarized content of the one or more subtitles based on a time lag between the video and the one or more subtitles; and
render the summarized content in one or more formats to the user over the screen of the media capturing device.

16. The non-transitory computer-readable medium of claim 15, wherein the region of attention of the user is captured on user invocation of the media capturing device.

17. The non-transitory computer-readable medium of claim 15, wherein the capturing the region of attention of the user comprises:
measuring at least one eye position of the user accessing the video.

18. The non-transitory computer-readable medium of claim 17, wherein the at least one eye position of the user accessing the video is captured with an internal camera on the media capturing device that provides associated coordinates of the screen.

19. The non-transitory computer-readable medium of claim 15, wherein the determining the one or more subtitles from the text script comprises:
mapping dialogues of the text script to characters in the video;
determining one or more characters in the region of attention of the user; and
rendering one or more dialogues of the one or more characters in the region of attention to the user as the one or more subtitles.

20. The non-transitory computer-readable medium of claim 15, wherein the one or more formats of the summarized content of the one or more subtitles comprises at least one of a text format, and a sign language format.

21. The non-transitory computer-readable medium of claim 15 further comprising:
classifying the user into one or more user types to address requirements of the user.
